(19) United States
(12) Patent Application Publication
(10) Pub. No.: US 2018/0293371 A1
(43) Pub. Date: Oct. 11, 2018

(54) METHOD AND DEVICE FOR AUTHENTICATING AN OBJECT OR A PERSON USING A SECURITY ELEMENT WITH A MODULAR STRUCTURE

(71) Applicant: Friedrich KISTERS, Kreuzlingen (CH)

(72) Inventor: Friedrich KISTERS, Kreuzlingen (CH)

(21) Appl. No.: 15/764,680

(22) PCT Filed: Sep. 29, 2016
(86) PCT No.: PCT/EP2016/073222

§ 371 Date: Mar. 29, 2018

(30) Foreign Application Priority Data
Sep. 30, 2015 (DE) 10 2015 116 627.5

(51) Int. Cl. G06F 21/34; H04L 29/06

(52) U.S. Cl. CPC G06F 21/34; H04L 63/0853

(57) ABSTRACT

The present invention relates to a method and an authentication device for authenticating an object or a person by means of a security element, which is individually assigned to the object or to the person and has a plurality of security features. The security element is comprised of a plurality changeable modules with a plurality of surfaces, wherein at least some of the modules have specific security features and single or all modules are individually combined to form a new, changed security element. At the enquiry time-point, the visual appearance or a property of the changed security element is recorded and compared with the reference feature stored in the database, in order to authenticate the object or the person.

### TECHNICAL FIELD

The present invention relates to a method and a device for authentication of an object or a person by means of a dynamic security element which is individually assigned to the object or person and has a modular structure.

### STATE OF THE ART

To authenticate a person or objects, different methods and security systems are known so as to make an identification as forgery-proof and attack-proof as possible. In most cases individualizing features such as passwords, biometric features, holograms or physically/chemically measurable security features are assigned to a particular object, a service or a person. During authentication the particular security feature is detected and compared with stored reference features. If the transmitted security features match the reference features to a certain degree, the object or the person is positively authenticated. Whatever the nature and the structure of the security element used for authentication, such authentications are mostly based on static security features that remain unchanged, at least for a certain period. However, static security features can be easily forged with corresponding time and effort.

Although there are methods, in which, for example, a code or a password is dynamically changed over a period of time using an algorithm or other security identifiers, in order to make the code or password more secure, but such processes run mostly automatically in the background, without the user being able to directly influence. Thus, GB 2 265 482 A describes a method for transmission of a dynamic code as a security feature, which varies according to an algorithm.

Further, efforts have been made to take advantage of, for example, physical properties of a substance as security characteristics. For instance, EP 1 158 459 A1 describes a method, in which the luminescence curve of a luminescent probe is used as a reference characteristic, which serves as the basis for authentication. For authentication, a determined luminescence curve is compared with the stored reference curve via a point-to-point comparison using the luminescence decay.

In addition, there are security signs, which are based on random patterns, which are applied on the object to be labelled, such as applied to a product. Due to the complexity of a chaotic random pattern security should be increased. Such a method is described in DE 103 04 805 A1. A fingerprint containing the individual characteristics of the pattern is extracted from the read-in random pattern.

There are also dynamic features that may change due to external or internal influences. Such a security element is described, for example, in DE 10 2009 033 221 A1, in which the security element has, at least in certain regions, one craquelure pattern in the form of cracks, break-outs, abrasions or shrinkage as well as possible contaminants, which can be scanned and detected as security features. A similar approach was pursued in U.S. Pat. No. 7,793,837 B1.

Although different security features are applied to or integrated, for example, on a bank note or a credit card, but these features with regard to the presentation and arrangement are rigid and cannot be easily altered. A number, a hologram or a magnetic strip will remain always in the same position of the object (for example, the currency note or credit card). Therefore, a counterfeiter can, with suitable effort, create a copy of the security element, which is far more difficult with dynamically changing security elements, since the counterfeiter does not know the state of the security features valid at the time of the authentication.

Module-type components are already known. Thus, US 2014/0189798 A1 describes a three-dimensional cube object, in which individual blocks with textures are provided. Here, individual 3D elements are changed at random, for example, its position or orientation in relation to the other 3D elements, and then reassemble them into a correct pattern. The aim of the method is to determine whether the assembling of the pattern is done by a machine or a human being. The embodiment assumes that only one person will succeed in restoring the pattern. The use of such 3D elements for authentication is not part of this document. The US 2011/0090145 A1 describes a cube, wherein input areas are provided so as to enter a code (password or ID data) for authentication. Thanks to the three-dimensional tape, thus only more input areas are created, as is the case, for example, with a touch screen or a computer keyboard. Otherwise, puzzles are known, which can take different forms of design already, as described in U.S. Pat. No. 3,655,201.

### SUMMARY OF THE INVENTION

Against this background, it is an object of the present invention to provide an alternative authentication method and authentication device with which an object or a person can be identified/authenticated via a dynamically changing security element and that can be altered by a user himself.

This object is solved by a method having the features of claim 1.

Preferred embodiments can be found in the dependent claims again.

The inventive method enables authentication of an object or a person by a security element individually assigned to the object or person having multiple security features for authenticating the object or person.

The term “object” in the context of the present invention is to be broadly construed and includes, for example, any kind of objects, as well as computer programs or services of a service provider (such as a payment system). Typically objects to be identified are, for example, documents, securities, stamps, labels, bills, bank notes, passports, identity cards, credit cards, passports, tickets, driver's licenses, vehicle documents, postage stamps, labels, vignettes, art objects, furniture, measuring instruments, machines and machine parts, vehicles, technical equipment, communication devices, mobile phones, computers, data carriers, printed matter, books, materials, products, technical equipment, tools, paper and cardboard, packaging or even living beings such as humans, animals or plants.

Under the concept “changeable module” is meant a module, which can be changed either by itself or relative to other modules in its shape, location, arrangement, and presentation. This can be done, for example, by shifting or twisting, deforming or loosening/connecting individual or several modules. Further, the modules can also be modified by applying or inserting a security feature on or in the surface of a side of the module. In addition, the modules can influence each other and therefore change their properties depending on their position relative to each other. This may be the case, for example, if a module, that produces an induction current comes to rest next to a module that absorbs induction current and as a result changes it colour, or begins to light up.

The inventive security element consists of changeable modules with a plurality of surfaces. Preferably, the modules on the security element are movable, twistable or detachably connected to one another. Preferably, the modules are three-dimensional components or bodies that can either be held together movably, or can be detachably inter-connected via corresponding coupling parts. Several composite three-dimensional modules form the actual security element. At least a portion of the modules has specific security features, which give a specific appearance or a property of the security element (e.g., a physical or chemical property), which can be detected by corresponding detection devices. The security features are preferably formed on one of the surfaces of the modules, but can also be located within, or can show a material property. For example, one or more modules may be deformable and have a shape memory. A dynamic change of the security feature is caused in this variant by deformation, whereby an altered appearance is created.

The inventive security element can be dynamically altered, preferably in that the security features arranged on the modules change dynamically, or wherein the modules themselves or their location, shape, visual appearance or other characteristic change relative to a reference from an earlier time point. It is preferably foreseen that one or more security features or modules or the modules themselves change dynamically between two authentication points in time. In this case, individual modules can also influence one another and thus effect the change.

The dynamic security arises, for example, by the fact that the individual modules can be arranged together to form a three-dimensional security element in various type and manner, thereby changing the visual appearance or the properties of the security element on one or more sides. Preferably, the modules comprise a geometrical body, such as a cube, a cuboid, a cylinder, a pyramid, or a sphere that can be linked to form a three-dimensional structure or knitted structure. Preferably, each surface of a module has different security features. In the example, in the case of a cube, at least six different sides can have security features based on six available surfaces, since each individual surface of a module or parts thereof characterize the visual appearance of the security element. If a large number of uniform or different modules are combined to form a complex security element, then a plurality of possible combinations or arrangements are obtained that characteristically change the visual appearance of the security element.

Another security-increasing factor is that a potential counterfeiter does not know which side or which modules of the three-dimensional security element are detected by the detection device. Even more security-enhancing parameters, such as the scanning angle or the sensing area of the security element, as chosen by the detection device, result in further variables, which increase security. In a preferred embodiment the detection device, therefore, scans the security element with different scan angles, cut-outs or perspectives. Preferably, the security element is analyzed using different detection devices, for example, by analyzing the surface structure, the visual appearance or physical/chemical properties.

According to the invention, a variant now comes in addition that at least one security feature of the security element can be altered between two interrogation points of time, i.e., the security element undergoes a dynamic change process. The dynamic change process can either comprise the change of at least one security feature of the security element or a change in the modules themselves. This may concern, for example, the position, the shape, layout and visual appearance, which relate to the location of the modules relative to other modules or any other characteristic of the modules. The change can be carried out by the user himself, an external factor or an inherent trigger (for example, a characteristic of a substance, a physical or chemical change in a material property). However, it is also possible that an authentication device specifies a particular appearance for authentication to the user, so that the user must adjust the security element correspondingly by arranging the modules.

In a further variant, provision can be made that the detection device itself (for example, a camera or a sensor) causes a change of the modules. This can, for example, take place via the effect of heat, radiation, printing or mechanical action.

In a preferred embodiment, the security element is transferred to an “inactive” state, in which one or more modular components are stored at different locations or consciously modified at the security element. For example, a module can be twisted or moved to a different location on the security element with an adjacent module, thereby changing the appearance of the security element. This means that no authentication can be done during a loss or theft, since the unauthorized person does not know the “active state” of the security element, in order to assemble the modules for a security element valid for authentication.

Preferably, there is a reduction of authorizations by removing or adding modules or security features of the security element, whereby even new modules can be activated or existing modules can be deactivated. The reduction can take place in stages and are weighted differently depending on the authorization. This ensures that a user will have access only to certain authorized areas. In addition, a temporary deactivation of the security element offers a higher security because in case of a loss of the security element the attacker does not know the active appearance and the active status. For authentication, the security element can then be activated again by restoring the valid state. Also the reverse is possible, namely that authorizations are granted by active states of the security element, preferably by defining different active states for the respective authorization.

In a further variant, one or more modules can also be separated or shared from the actual security element and stored in different locations for a positive authentication. The security element is not complete and “active” when the individual modules are reassembled into correct, valid security element. Thus, it is possible to distribute even individual modular components among different people or places. Only upon correct combination of individual modular blocks to the security element provided for authentication, a positive authentication of the person or of the object can be performed. In this way, individual authorizations can also be controlled, in which, for example, one or more modular units will have to be arranged for a certain visual appearance, in order to obtain access. Even “blocking modules” are possible, with which, for example, a service provider can exclude a user from logging on if such a module is located in the security element.

As part of authentication or pre-authentication it can also be specified that there must be a certain number of changes, so that a user is positively authenticated. Further, the number of changes can be set, for example, the minimum and maximum number of changes starting from the original state. This has the advantage that for protection against misuse of the user intentionally a change can be made that must be reversed in the next authentication process so as to enable a positive authentication for the security feature.

For an authentication, a comparison of the security features is necessary with corresponding reference features, for which a visual appearance or a property of the security element is stored as a reference feature in a central database. At the query time, the visual appearance or property of the altered security element is detected and compared with the stored reference feature in the database for authentication of the object or person. If a previously defined degree of conformity between the detected security feature and reference feature stored in the database is present, then an authentication is positive.

In a preferred embodiment, a modified security element is stored as a new reference feature in the case of a positive authentication. Thus, for example, a user can combine the individual modules differently and thus create a new security element with new individual security features. This will differ in at least one feature, preferably in a number of features, from the original security element, depending on how many modules of the security element are modified. Thanks to the modular arrangement of the security element, it is known only to the user, how he has to arrange the individual modules for the correct visual appearance.

In a preferred embodiment, it can be determined that the security feature must change according to a predetermined rule. Such a rule may provide that the security element may never be identical twice. Another rule may provide that the security element at specific times must have a specific appearance. Even allowing or not allowing certain modules for authentication can be part of a rule.

Preferably, for positive authentication, it is foreseen that the security element present at the query time has partly changed compared with the reference feature stored in the database, wherein the degree of change is determined so that it can be decided that the security element present at the query time has emerged from the reference feature stored in the database.

The dynamic change of the security feature of the module or modules themselves takes place continuously, resulting in a changed visual appearance or property of the changed security element, which is related to the reference feature stored in the database. A forgery of the security element would be discovered so fast that it evolved different from the original. At the next authentication attempt, the system would trigger the alarm and expose the forgery. The user of the original is warned.

According to the invention, a forgery can be detected, characterized in that at least one security feature of one module or more modules or the modules themselves have changed between two query times or within another defined period of time. It is provided that the degree of change is defined in such a way that there is a relationship to the reference feature stored in the database, i.e., the security feature available at the query time has preferably only slightly changed compared to the reference feature stored in the database, for example, a degree of change of <10% is preferred. In a further variant, a degree of change is chosen, which lies between 0.1% and 99% compared to the reference feature stored in the database, wherein all intermediate values of this range are included. If now an authentication is made with a fake security element, then this security element is stored in the database as a new reference feature. If now another authentication attempt is made with the original security element, then this will have changed dynamically in a different way than the forgery. In this case, the authentication system would issue an alarm so that the user knows that there is a fake in the system. The user can then take appropriate measures.

The security element or individual modules of it can also change typically or atypically, for example changes taking place as a result of rules. Thus, for example, a provision can be made such that the modules twist in a certain direction or assume a different position relative to other modules. The regulatory compliance of the security element is then queried at the query time. Preferably, the rule compliance is based on a material property or physical property of the security element or its modules. Non-compliant appearances of the security element or individual modules would stand out during authentication and trigger an appropriate alarm.

In a preferred variant of the security element, individual modules are arranged in different levels, which are displaceable relative to one another or rotatable. Preferred are also multilayer structured security elements. For example, different surfaces of the modules can be moved by rotation or by sliding in the detection direction.

The detection of visual appearance of the security element or a part thereof is preferably carried out by a sensor. The optics of a smartphone, for example, are suitable for authentication while on route. The optical image thus obtained is transmitted for authentication as digital image, if necessary, stored in the database as a new reference feature.

In addition to an optical detection, other detection methods are possible for detecting security features, which are not easily detectable by optical means. These include, for example, capturing luminescent materials, electromagnetic fields or magnetic fields. For this reason, in a preferred variant, one or more modules of the security element are preferably equipped with a dye, a luminescent dyestuff, magnetisable particles, a magnetic surface, a machine-readable code, a display or a radiation-emitting element. A radiation-emitting element is, for example, an LED or a RFID (radio frequency identification) chip.

In a preferred embodiment of the invention, a module of the security element includes a reader for an RFID chip. In this way, modules can also influence one another. Also, the spatial distances of the module assembly can also play a role when modules have correspondingly sensitive transceivers. If the distances do not match the stored profile, the authentication is negative.

If a module is equipped with a display, then individual security features, such as an image, a pattern or a colour presentation can be displayed directly on the display mounted on the module. The image, pattern or presentation of the display can be changed between two authentication time points, thereby a new, modified security feature is created, which in turn gives the entire security element a new look, which can be stored in the database as a new reference feature.

To further increase security, besides the modular security element, a pre-authentication can be carried out in addition, in which a user initially logs in to a service provider using an identification identifier and authenticates as a user, then a security feature is transmitted to the user, who records the security feature, and retransmits it back to the service provider, where the transmitted and retransmitted security feature is compared and released if it matches. Preferably, an independent authentication facility is provided, which manages, checks and releases the security requests of several service providers as required.

Alternatively, a pre-authentication can be done, in which a user first logs on to a service provider via an identification identifier and authenticates as a user, the service provider then logs on to a further independent authentication facility, and authenticates himself and the service provider upon successful authentication transmits the user request to the further authentication facility, the further authentication facility then transmits a security feature to the user and the service provider, which the user transmits back to the service provider and to the further authentication facility, wherein the user is then successfully authenticated, if the security features transmitted to the service provider and the further authentication facility match.

According to the invention, the at least one security feature is applied to or integrated into a surface of the module. For example, the safety feature may be applied as an ink on the surface of the module. In addition, changes in the material of a module are also possible, for example, to create individual patterns or cracks. Also, the material itself can also have properties that are individual and can serve as a security feature. These include, for example, the colour or radiation-active substances which have been incorporated into the material during production, such as colour particles or magnetic particles. Furthermore, deformations of individual modules are possible. The shape, position, arrangement of the modules determine the visual appearance of the security element. Further, the influence of modules among one another is encompassed by the invention. Thus, for example, a provision can be made that the position or property of a module is changed, in which another module activates the same or is dynamically changed in other ways.

In a further advanced variant it may also be provided that certain modules of the security element are assigned to a specific program, a service, an object, an access, an institution or a person. For example, a financial institution can issue individual modules to specific users or a specific group of users, which makes it possible to limit the number of users. This is of particular significance for, e.g., authorities or security services, in which individual modules have an individual presentation and can be used only by authorized users. Unauthorized users are usually not in possession of such modules, which further complicates possible forgery or unauthorized access. Preferably, a sample check may be provided, in which the security element is checked to see whether certain modular components are located in the security element and match to a stored reference pattern. If, for example, a user is a customer of several financial institutions, then the customer may have received an individual module from each financial institution, which is part of his individual security element. For successful authentication, it is necessary that all module components are present in the security element. Even their correct position and direction can be relevant.

In a preferred embodiment, one or more modules of the security element generate a magnetic field, which is detected via screen sensors, position sensors, or magnetometer, or other detection device, if need be, together with further security features, and compared for authentication with the reference features. Depending on the arrangement of the modules, the magnetic field is altered, which in turn can be detected through recording means (e.g., magnetometer).

The present invention also relates to an authentication device, which in addition to the aforementioned security element is additionally equipped with a detecting device for detecting the security features and a communication device for transmitting the detected security features to a matching device. The matching device compares the visual appearance as transmitted or a property of the security element at the time of authentication with a reference feature stored in a central database.

Preferably, the individual modules of the security element are detachably linked to each other via a plug connection, a clamp connection, a latching connection, a screw connection, a lace connection, a Velcro connection or magnetically as coupling pieces.

The inventive security element can, for example, be connected to an object (such as, for example, a key fob) or a piece of jewelry. To increase the security, a provision can be made that one or more modules of the security element are divided, i.e., for a valid authentication, the user would have to correctly reassemble the modules divided into the different objects. It is also possible to distribute security elements over several users, so that a individual user does not receive access, but all relevant users must be present in order to receive access.

Security elements can also have several levels and be openable, whereby the different levels, such as individual modules, can have different authorizations and functions. For example, individual levels or modules can switch-on actively or passively the parts of the security element or the entire security element.

The invention is further illustrated in the following drawings.

### WAYS OF PERFORMING THE INVENTION AND INDUSTRIAL APPLICABILITY

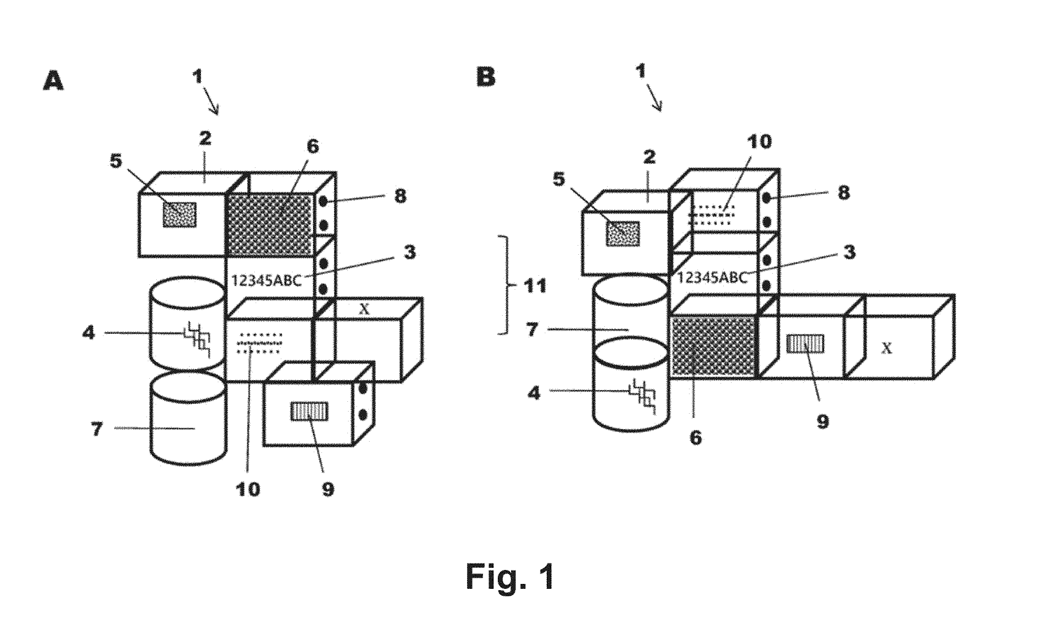

FIG. 1 shows an inventive security element 1 with several of body-like, three-dimensional modules 2, whereby each module 2 is detachably connected with respect to an adjacent module 2. The individual modules 2 are connected via coupling pieces 8, which are located on the module walls of individual modules 2. The coupling pieces 8 can form, for example, a plug-in, clamping, folding or locking connection. Instead of coupling elements 8, even Velcro fasteners, rails, chains or other types of connections can be provided.

Each module 2 comprises a number of different security features 11, wherein a selection of security features 11 give an individual visual appearance that can be assigned to a particular user, an object, a person or an action. Such security features 11 are, for example, a code 3, or a pattern 10 that are deposited on a surface of a module 2. An additional dynamic code 3 is preferred. Dynamic code 3 will have to change the characteristic within a time interval.

In addition, the safety characteristic 1 can also be incorporated directly into the material, for example, in the form of cracks, fissures or recesses 4. A module 2 can also have a display device in the form of a display 5, on which, in turn, different, individual security features, for example, in the form of an image, pattern or shade variations can be displayed. Here, the security features 11 may change temporarily. With a display 5, for example, a modified image can be displayed, creating a dynamic security feature 11.

In a further module 2, colour or magnetic particles 6 may also be included. The colour particles can, for example, relate to luminescent dyes. Even other machine readable materials are conceivable.

A further module 2 can itself be magnetic, wherein it is made of a magnetic material 7. In addition, radiation or energy sources 9 can be applied on a module 2 as a security feature 11, for example, a light source (such as LED) or a RFID (radio frequency identification) chip. Using corresponding transmitter-receiver systems, such chips can be read. Several modules with such chips can also lead to a security element 1 that can be recognized as dynamic combination, which depending on the number and location of the modules 2, allows additional or alternative accesses. The same holds good for magnetic fields that also change with a change of the module assembly and thus generate a new security feature 11, which is dynamically changed and can be detected using probes. In addition, the modules 2 may be configured as reader modules that identify other modules 2 directly within the security element 1 and display the correct identification visible or readable. Even the activation of the identified modules 2 is possible.

FIG. 1 A shows a variant, wherein different modules 2, which are provided with individual security features 11, are arranged in a specific manner. The detachable connection or a twisting of the modules 2 enables a change in the presentation of the security element 11, thereby changing the visual appearance of the sum of the security features 11, as well as individual security features 11. This situation is shown in FIG. 1 B, where individual modules 2 are arranged differently from the initial situation.

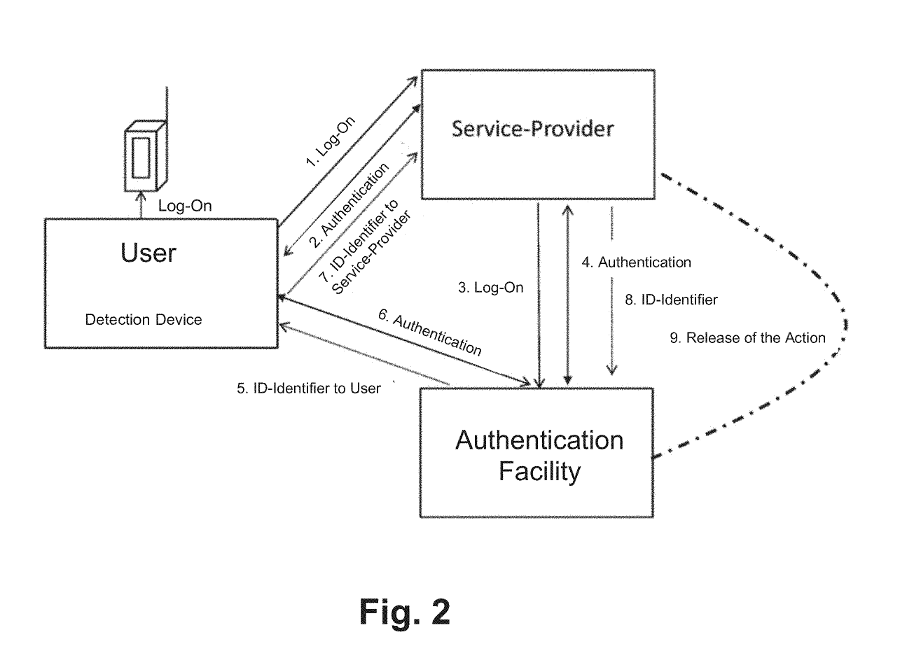

FIG. 2 shows a variant, in which the application of the security element according to the invention can be used as part of an authentication device. In the case of a service provider, the process of authentication of a user runs in several steps. In the first step, the user logs on to the service provider and there is an authentication of the user with the service provider. In a third step, the service provider logs on to an independent authentication facility and is authenticated in a fourth step using a defined authentication method. Then, an identification identifier (for example, an action code) is sent to the user, when the authentication of the user is successful. The user (or his device in the background) transmits the identification identifier in the seventh step, as shown, to the service provider, who finally transmits it to the authentication facility. The authentication facility checks the identification identifier to see if it matches the identifier originally transmitted. Only then the service provider receives clearance to execute the service requested by the user.

Alternatively, the user can also contact the authentication facility directly in the first step and authenticate himself. The authentication facility then connects to the service provider and also authenticates itself using a predefined authentication method.

In an alternative variant, first authentication of a user towards his communication device, e.g., a mobile device, takes place by entering and sending a user ID. This can be done, for example, by capturing an individual visual appearance of the ingenious security element with a Smartphone camera or other sensors, and comparing it with a stored reference image. These include, for example, position sensors or magnetometer.

After successful logon to the communication device, the user logs on to a service provider which offers a specific service (for example a financial transaction service). This can also be done using the ingenious security element, which is used as the ID key for authentication. After successful registration of the user with the service provider, the latter does not respond directly to the users, but logs on to a further authentication facility using an identification code. Upon successful authentication and establishment of this connection, the service provider sends the user query and, if necessary, further information or data to a further authentication facility. This in turn transmits the user an individual identification identifier, for example in the form of security elements (or their appearance), as described in the present application. Upon completion of this double identification, the users and service provider are securely authenticated with the independent further authentication facility and another connection channel can be opened. Further, the further authentication facility transmits an identification identifier to the user as well as the service provider, which the user uses for authentication with the service provider.

An identification identifier can, for example, also be sent as an image that is displayed to the user on a screen. The user can read out this identification code and thus complete the registration successfully. Preferably, the transmitted identification identifier is a unique security element according to the invention assigned to the user, which can continue to change dynamically in the manner described herein. In this method, an unlimited number of users and service providers can be authenticated separately authenticated via an independent authentication facility and then securely connected to each other.

If an authentication is carried out with the service provider or a check is done through a further authentication facility, an image of the inventive security element is transferred to the user, which is stored as a reference feature in a database with the service provider and/or the further authentication facility. The user can photograph this image for double authentication with his mobile phone camera and can send it back for identification. Simultaneously or alternatively, it is also possible that the user transmits a modified security element, which replaces the reference feature. To achieve this, he only needs to change the individual modules of the security element so that a changed security element is created.

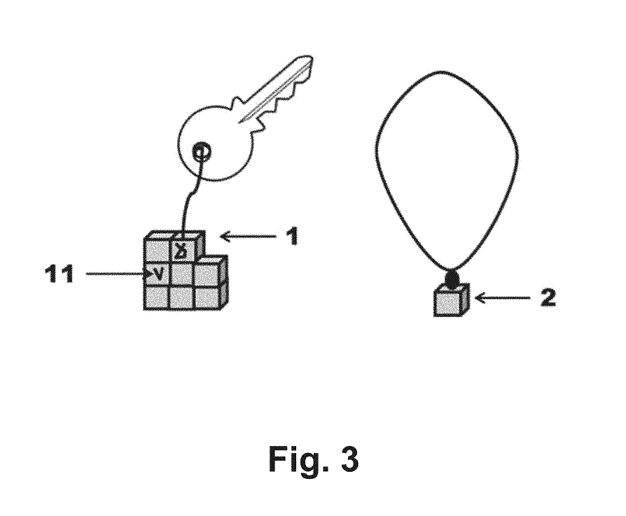

FIG. 3 shows an embodiment variant, in which one or several modules of the security element according to the invention are stored at different locations. In the embodiment shown, a module assembly is located on the key ring, and a further module, for example, on a necklace. By dividing the modules, a temporarily inactivated security element is created, whereby a potential counterfeiter does not know how to reassemble the individual modules, even if he were in possession of the key ring and the necklace, into the currently valid security element. Thanks to the modular layout of the security element, a shared storage is thus possible, which increases the security further. Further, single or several modules can also be deliberately varied by the user, wherein, for example, a module block is intentionally rotated to a different position. Consequently, an authentication would fail. In this case, the user, for activation of the security element, must transfer the concerned module or modules in the correct position, so that the authentication runs positive.

Due to the modular construction of the security element, a plurality of combinations is possible, which embosses a characteristic layout of the inventive security element, and thus the visual appearance. A provision can be made that only a part of the security element changes as part of authentication, while another part remains static, i.e., unchanged. Through a temporary inactivation of the security element, in which, for example, modules are deliberately changed so that they change the security element, whereby no more positive authentication is possible or in which the modules are stored at different locations, the security is further increased. For a successful positive authentication, the user must correctly assemble the security element first, so as to authenticate positively.

1. A method for authentication of an object or a person through a security element individually assigned to the object or person having multiple security features for authentication of the object or the person, wherein at least one security feature of the security element is changeable between two enquiry time-points and the visual appearance or a property of the security element is stored in a central database as reference feature for comparison, wherein the security element is composed of a plurality of changeable modules having a plurality of surfaces, wherein at least a part of the modules has specific security features, wherein at the time of query the visual appearance or a characteristic of the modified security element is detected and compared for authentication of the object or person with the reference feature stored in the database, wherein the security element undergoes a dynamic change process between two enquiry time-points, in which either at least one security feature of a module is changed, or individual or all modules are combined into a new, modified security element.

2. The method according to claim 1, wherein, in the case of positive authentication a modified security element is stored as a new reference feature at the enquiry time-point.

3. The method according to claim 1, wherein for a positive authentication it is required that the security element present at the time of the query has changed partially vis-à-vis the reference feature stored in the database, whereby the degree of change is determined so that it can be determined that the security element present at the enquiry time-point is derived from the reference feature stored in the database.

4. The method according to claim 1, wherein at least one security feature of the security element or a module thereof, whose position, presentation, visual appearance, location in relation to other modules or any other characteristic is changed, whereby a modified visual appearance or a changed property of the security element or module is generated, which is preferably related to or derived from the reference feature stored in the database.

5. The method according to claim 1, wherein it is queried at the enquiry time-point whether the dynamic change of the security element is in conformity with the rules, wherein the conformity is based on a material property or physical property of the security element or its modules.

6. The method according to claim 1, wherein first a pre-authentication is carried out, wherein a user initially logs on to at least one service provider via an identification identifier and authenticates himself as a user, then a superordinate security feature is queried by an independent authentication authority, and a dynamic code is exchanged, and an action-specific action code is generated and sent to the user, which is sent back to the independent authentication authority via a service provider in order to execute the action as checked, whereby a comparison of the transmitted and re-transmitted security feature is carried out and a release takes place upon conformity.

7. The method according to claim 1, wherein first a pre-authentication is carried out, in which a user first logs in to a service provider via an identification identifier and authenticates himself as a user, the service provider then logs on to a further independent authentication facility and authenticates himself, and the service provider after successful authentication transmits the user request to the further authentication facility, the further authentication facility then transmits a security feature to the user and the service provider, which the user transmits back to the service provider and the further authentication facility, whereby the user is then successfully authenticated, if the security features transmitted to the service provider and the further authentication facility correspond to each other.

8. The method according to claim 1, wherein the at least one security feature is applied to or integrated in a surface of the module or consists of a material property, and that the individual modules are combined randomly or according to a rule with one another to form the security element.

9. The method according to claim 1, wherein the security element is deactivated by reducing the authorizations via removing or adding modules or security features of the security element, wherein new modules can also be activated or existing modules can be deactivated.

10. The method according to claim 1, wherein one or more modules, individually configured, of the security element are assigned to a specific program, a service, an object, an access, an institution or a person.

11. The method according to claim 1, wherein one or more modules of the security element generate a magnetic field that is detected via screen sensors or another detection device, if required, along with further security features and is compared with the reference features during authentication.

12. An authentication device for authenticating an object or a person, comprising a security element which is individually assigned to the object or the person having a plurality of security features for authenticating the object or the person, whereby at least a security feature of the security element is changeable between two enquiry time-points and the visual appearance or a property of the security element is stored in a central database as a reference feature for comparison, a detection device for detecting the security features, a communication device for transmitting the detected security features to a matching device which compares the transmitted visual appearance or a property of the security element with a reference feature stored in a central database, wherein the security element is composed of several changeable modules having a plurality of surfaces, wherein at least a part of the modules has specific security features and individual or all modules are combinable to a new, changed security element, wherein the security element undergoes a dynamic change process between two enquiry time-points, in which at least one security feature of the security element or a module thereof, its position, presentation, visual appearance, location in relation to other modules or any other property is changed, whereby a modified appearance or a modified property of the security element or module arises, and that the matching device compares the transmitted appearance or a feature of the security element with a reference feature stored in a central database.

13. The device according to claim 12, that wherein one or more modules of the security element as security feature are individually provided with a dye, a luminescent dye, flaws or cracks, magnetizable particles, a magnetic surface, a machine-readable code, a display, a pattern and/or a radiation-emitting element.

14. The device according to claim 12, wherein the individual modules of the security element are detachably interconnected via a plug connection, a clamp connection, a snap connection, a screw connection, a string connection, a Velcro connection or magnetically as coupling pieces.

15. The device according to claim 12, wherein the individual modules of the security element are of multilayered, rotatable, deformable, connectable and/or movable designed.

16. The device according to claim 12, wherein the matching device stores a modified security element as a new reference feature in the event of a positive authentication.
